(19) United States
(12) Patent Application Publication
(10) Pub. No.: US 2004/0033792 A1
(43) Pub. Date: Feb. 19, 2004

(54) Method and system for arranging or sorting channels

(76) Inventor: Joerg Schreiner, Frankfurt (DE)

Correspondence Address: KENYON & KENYON, ONE BROADWAY, NEW YORK, NY, 10004, US

(21) Appl. No.: 10/454,986

(22) Filed: Jun. 4, 2003

(30) Foreign Application Priority Data
Jun. 4, 2002 (DE) 102 24 697.1

(51) Int. Cl. H04B 1/18

(52) U.S. Cl. 455/150.1; 455/161.1

(57) ABSTRACT

In order to develop a method and a system for arranging or sorting receivable channels that transport emitted data and/or content, in particular broadcast channels, in accordance with at least one arranging or sorting principle, in such a way that even with a plurality of receivable channels, a simple, intuitive, and useful principle for arranging or sorting those channels is adhered to, it is proposed that the channels be arranged and/or sorted in accordance with the duration and/or intensity of the employment or use of the information and/or content transported by the respective channel.

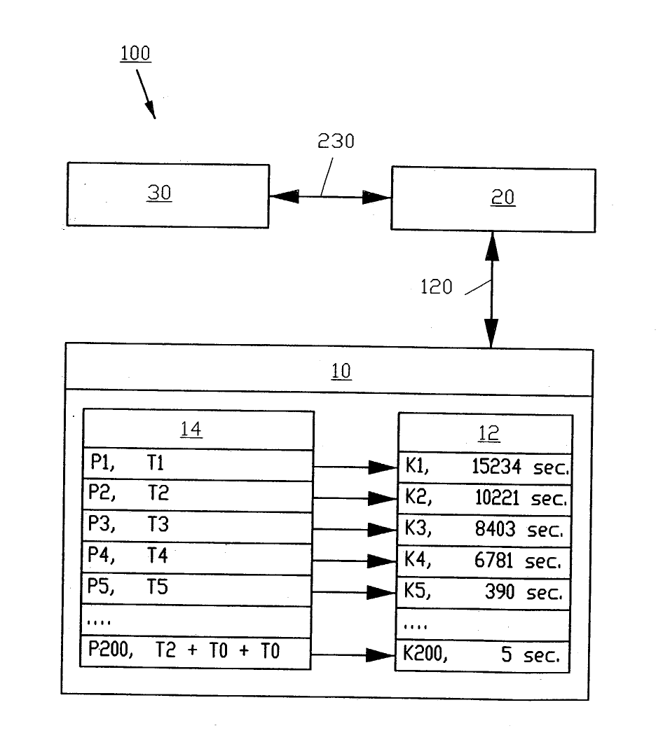

### FIELD OF THE INVENTION

The present invention relates to a method and a system for arranging or sorting receivable channels that transport emitted data and/or content, in particular broadcast channels, in accordance with at least one arranging or sorting principle.

### BACKGROUND INFORMATION

Receiving units, in particular television units or radio units, today make it possible to store received channels in so-called program locations. Depending on the receiving unit, from a few to hundreds of different memory locations are available. Allocation or assignment of the reception channels to the usually consecutively numbered program locations is accomplished either manually by the user of the receiving unit, or automatically by way of a special function of the receiving unit, hereinafter called automatic channel memorization.

Manual sorting by the user of the receiving unit is laborious and time-consuming for the user, but usually provides to the user the advantage that the reception channels are disposed in a sequence that is known to and conveniently accessible by the user. The reception channels most used by the user are typically stored in the most easily accessible program locations. The prerequisites for this programming are a list of the reception channels, and accurate knowledge by the user as to the programming of the program locations.

The advantage of automatic channel memorization, conversely, lies on the one hand in time saved during programming and on the other hand in the fact that the receiving unit can also locate new reception channels previously unknown to the user, and can automatically store them in the program locations. In broadcast receiving units, the stored reception channels are typically filtered in terms of reception properties, so that the limited number of program locations available for storage are not unnecessarily filled with poorly receivable stations. After automatic channel memorization, the reception channels are always distributed among the program locations in an unpredictable fashion.

To ensure that the frequencies most often used by the user are then located at the easily accessible program locations, the user is almost always forced to make a manual reallocation. In the coming age of digital broadcasting with hundreds of available channels, this manual sorting will become an operation that will exhaust the time and patience of the user.

### SUMMARY OF THE INVENTION

Proceeding from the disadvantages and shortcomings set forth above, and in consideration of the existing art outlined, it is the object of the present invention to develop a method of the kind cited above, and a system of the kind cited above, in such a way that even with a plurality of receivable channels, a simple, intuitive, and useful principle for arranging or sorting those channels is adhered to.

According to the present invention, channels are sorted by duration of use; in other words, the channels are arranged and/or sorted in accordance with the duration and/or intensity of the employment or use of the information and/or content transported by the respective channel.

According to a particularly inventive development of the present method and the present system, in this context the reception channels most used and/or most intensively used by the user are automatically distributed to the most easily accessible and/or best accessible program locations.

This yields firstly the advantage that the stations stored at the program locations can easily be updated with new stations without disrupting the “personal” sequence of most-important reception channels with which the user is familiar.

A further advantage of the present invention may be seen in the fact that the user can easily and repeatedly use reception channels previously unknown to him or her, since those reception channels can easily be stored at the program locations with no need for the user to know the list of available reception channels.

According to a particularly advantageous development of the present invention, stations used for a longer period can be automatically shifted to the more-easily accessible program locations, allowing the user to jump quickly back and forth between his or her preferred or “favorite” channels. In this connection, continuous updating according to the present method entails the further advantage that despite this continuous updating of the channel selection, the user does not lose the overview of his or her preferred or “favorite” channels.

Furthermore, it proves to be advantageous both in terms of the present method and in terms of the present system that the underlying principle according to the present invention—that of channel sorting based on duration of use—can be used independently of previously known arranging/sorting methods (as described in the existing art) without modifying their mode of operation.

Lastly, the present invention accordingly concerns a receiving unit, in particular a broadcast receiving unit, operating in accordance with a method of the kind set forth above and/or having at least one system of the kind set forth above.

A sorting device based on duration of use can therefore, according to the present invention, be used in all receiving units in which a received channel can be allocated to one of several program locations; these are, in particular, broadcast receiving units for digital audio, digital video, television, radio, and/or videotext programs, as well as other receiving units for digital media, for example for the Internet or for the Wireless Application Protocol (WAP).

The present invention functions independently of the specific number of channels, and independently of the specific number of program locations; the present invention moreover functions independently of the selection or manual programming of a specific program location, and of the specific reception channel assigned to that program location.

### BRIEF DESCRIPTION OF THE DRAWING

The FIGURE schematically depicts the principle of an exemplified embodiment of a system according to the present invention that functions in accordance with the method according to the present invention.

### DETAILED DESCRIPTION

The FIGURE outlines the functional principle of a system 100 for arranging or sorting two hundred receivable broadcast channels K1, K2, K3, K4, K5, . . . , K200, which transport emitted data or content, in accordance with an arranging or sorting principle. The output unit combination of system 100 can be configured as follows:

A broadcast receiving unit (television) measures, in a central computer unit 20 having a memory unit 10, the time during which each station frequency selected on the broadcast receiving unit is used by the user, and stores that time in a list 12 (=so-called channel list) of station frequencies being used; this channel list 12 can be automatically sorted, in computer-assisted fashion, by duration of use.

For example, in the exemplified embodiment shown in the FIGURE, the user of the broadcast receiving unit has so far employed, i.e. used, the respective data and respective content

of first channel K1 for exactly 15,324 seconds;

of second channel K2 for exactly 10,221 seconds;

of third channel K3 for exactly 8,403 seconds;

of fourth channel K4 for exactly 6,781 seconds;

of fifth channel K5 for exactly 390 seconds;

. . . and of two-hundredth channel K200 for exactly five seconds.

Two hundred program locations P1, P2, P3, P4, P5, . . . , P200 are stored in a second list also kept on hand in memory unit 10, namely in the so-called program location list 14, using the key combinations T1, T2, T3, T4, T5, . . . , T2+T0+T0 necessary in each case for selection, specifically sorted as to how accessible the key combinations T1, T2, T3, T4, T5, . . . , T2+T0+T0 are to the user.

The individual station frequencies (=channels K1, K2, K3, K4, K5, . . . , K200) from channel list 12 are now, according to the present invention, each allocated or assigned to a program location P1, P2, P3, P4, P5, . . . , P200 from program location list 14. According to the present invention, the channels K1, K2, K3, K4, K5 that are employed and viewed most often and for the longest time are allocated or assigned to program locations P1, P2, P3, P4, P5 that are most easily and best accessible; these program locations P1, P2, P3, P4, P5 are easily and quickly selectable and accessible by using keys T1, T2, T3, T4, T5 provided on the remote control device.

This allocation or assignment can change with each new sorting of channel list 12 and with a change associated therewith in the numbering or sequence of channels K1, K2, K3, K4, K5, . . . , K200.

The arranging or sorting can be performed automatically in computer-assisted fashion (→central computer unit 20, which is connected via a connecting line 230 to a broadcast receiving unit 30 for receiving the station frequencies), or manually. A threshold value, established automatically or definable by the user, decides the duration of use (in seconds) below which infrequently-used station frequencies can be automatically replaced by station frequencies that are offered but are not presently stored in memory unit 10.

Lastly, it should be noted that in the context of the present invention the term “broadcast” (“Rundfunk” in German, often also referred to as “Radio”) is not limited to what is often understood thereby, namely audio broadcasting transferred via an amplitude-modulated (=AM) or frequency-modulated (=FM) broadcast frequency; instead, “broadcast” is to be understood here as a transmission of information of an information provider to a plurality of receivers.

An example that may be cited, in addition to known AM or FM audio broadcasting, is e.g. terrestrial digital audio broadcasting, abbreviated DAB; digital satellite-based broadcasting or digital satellite radio, abbreviated DSR; as well as satellite television, cable television, and terrestrial television.

“Broadcast” in the context of the present invention is furthermore not limited to wireless “radio” transmission by electromagnetic waves, but rather extends therebeyond both to wireless transmission and to cable-based transmission, for example via optical fiber lines or copper lines.

What is claimed is:

1. A method for one of arranging and sorting receivable channels that transport one of data and content that is emitted in accordance with one of at least one arranging principle and at least one sorting principle, comprising:
at least one of arranging and sorting the receivable channels in accordance with at least one of a duration and an intensity of one of an employment and a use of the one of the data and the content transported by a respective one of the receivable channels.

2. The method as recited in claim 1, wherein:
the receivable channels include broadcast channels.

3. The method as recited in claim 1, further comprising:
one of allocating and assigning the receivable channels to program locations having at least one of a numbering and a sequence corresponding to one of the at least one arranging principle and the at least one sorting principle.

4. The method as recited in claim 3, further comprising:
one of allocating and assigning those of the receivable channels that are one of most frequently and most intensively one of employed and used to the most accessible program locations.

5. The method as recited in claim 1, further comprising:
one of arranging and sorting the receivable channels in at least one channel list;
one of allocating and assigning entries in the channel list to entries in at least one program location list; and
defining at least one of a numbering and a sequence of the entries in the at least one program location list by the one of the at least one arranging principle and the at least one sorting principle for the entries in the channel list.

6. The method as recited in claim 1, further comprising:
one of allocating and assigning at least one key to each individual program location.

7. The method as recited in claim 6, wherein:
the at least one key is of at least one operating unit.

8. The method as recited in claim 1, further comprising:
defining a threshold value one of automatically and by a user; and
replacing by other channels those of the receivable channels whose at least one of a measured duration and an intensity of one of an employment and a use falls below the threshold value.

9. The method as recited in claim 8, wherein:
the replacing is done automatically.

10. A system for one of arranging and sorting receivable channels that transport at least one of data and content that is emitted in accordance with one of at least one arranging principle and at least one sorting principle, comprising:
an arrangement for defining the one of the at least one arranging principle and the at least one sorting principle by at least one of a duration and an intensity of one of an employment and a use of the at least one of the data and the content.

11. The system as recited in claim 10, wherein:
the receivable channels include broadcast channels.

12. The system as recited in claim 10, wherein:
at least one channel list is provided for the receivable channels, those of the receivable channels in the at least one channel list can be one of allocated and assigned to program locations in at least one program location list; and
at least one of a numbering and a sequence of the program locations in the program location list is defined by the one of the at least one arranging principle and the at least one sorting principle for those of the receivable channels in the at least one channel list.

13. The system as recited in claim 12, further comprising:
at least one memory unit for storing the receivable channels and the program locations;
at least one central unit connected to the memory unit; and
at least one receiving unit connected to the at least one central unit.

14. The system as recited in claim 13, wherein:
the at least one central unit includes a computer central unit, and
the at least one receiving unit includes a broadcast receiving unit.
